(19) United States
(12) Patent Application Publication
(10) Pub. No.: US 2026/0249263 A1
(43) Pub. Date: Aug. 27, 2026

(54) VESSEL WITH JACKETED HEAD

(71) Applicant: Hargrove and Associates, Inc., Mobile, AL (US)

(72) Inventor: Benjamin Turner, Roswell, GA (US)

(21) Appl. No.: 19/064,129

(22) Filed: Feb. 26, 2025

(51) Int. Cl. B01J 19/00; B01J 19/26; F16B 5/08

(52) U.S. Cl. CPC B01J 19/0013; B01J 19/26; F16B 5/08; B01J 2219/00094

(57) ABSTRACT

A pressure vessel with an external jacket for temperature control of contents within the vessel is provided. The vessel has a shell and two opposing heads. The external jacket is installed on at least one of the heads, and heating or cooling fluid is circulated through the jacket for temperature control. The jacket is formed by a plurality of concentrically arranged conduit rings that are welded to the exterior surface of the head of the vessel. Adjacent conduit rings are connected by jumper lines to allow the heating or cooling fluid to flow between conduit rings. Each conduit ring has flared side portions that allow the side portions of adjacent conduit rings to be welded to the vessel in a single weld pass. A circular groove may be machined into the head of the vessel, and the outermost conduit ring may be welded to the head at the circular groove.

### FIELD OF THE INVENTION

The present disclosure refers generally to a vessel with one or more jacketed heads and a method of manufacturing a vessel with jacketed heads for temperature control of contents within the vessel.

### BACKGROUND

Jacketed vessels are commonly used in chemical processes requiring temperature control of the contents of a vessel. For instance, jacketed reactor vessels may be utilized as batch or continuous reactor vessels when a reaction process requires heating or cooling of process fluids inside the vessel. The jacket is disposed around the exterior of the vessel and provides a conduit through which heating or cooling fluid may be circulated to facilitate heat transfer between the heating or cooling fluid and the walls of the vessel. On vessels having a shell with two opposing heads, jacketing may be installed on the exterior of the shell, the heads, or both the shell and heads. Though internal coils may also be utilized as a conduit for heating or cooling fluids used to control vessel temperature, a jacketed vessel may be advantageous in processes involving highly corrosive or highly reactive materials since the jacket is external to the process fluids contained within the vessel. An external jacket may also reduce the risk of contamination due to heating or cooling fluid mixing with process fluids due to leaks in internal coils.

Common types of jackets used in jacketed vessels include conventional jackets, dimple jackets, and half-pipe jackets. A conventional jacket comprises a second, external shell that covers at least a portion of the shell and/or heads of the vessel and provides a space through which heating or cooling fluid may be circulated. A conventional jacket is simple to construct but is generally inefficient for heat transfer due to flow characteristics of the heating or cooling fluid inside the jacket. A dimple jacket has dimples that impart turbulence to the heating or cooling fluid as it flows inside the jacket. A half-pipe jacket comprises conduit formed by splitting pipe lengthwise, typically at an angle of 180 degrees (evenly down the middle of the pipe) or 120 degrees, or by bending a flat plate into a half-pipe shape. The conduit, or “half-pipe,” is then positioned around the exterior of the vessel shell and/or heads in a spiral orientation and welded to the exterior of the shell or heads to form a spiraling passageway through which heating or cooling fluid is circulated. Half-pipe jackets provide good heat transfer and may be preferred for high-temperature applications. Half-pipe jackets may also be divided into multi-pass zones, which cover different sections of the vessel and generally provide for greater flexibility in heating or cooling. For instance, on cylindrical vessels having heads at opposing ends of the shell, half-pipe jackets may be installed on the exterior of the cylindrical side wall of the vessel and/or on one or both of the opposing vessel heads. Jacketing installed on the side wall may be continuous with jacketing on the heads or may be isolated from the jacketing on the heads to form separate zones. The types of heads on which jacketing may be installed include torispherical heads, hemispherical heads, elliptical heads, flat heads, spherical caps, conical heads, or any other suitable type of head.

However, there are a number of problems with existing half-pipe jacket designs. For instance, a limited surface area of the exterior surface of the vessel shell or head is covered by a conventional half-pipe jacket due to spacing between adjacent passes, or arcs, of the half-pipe jacket. A certain amount of spacing between adjacent arcs is generally required to provide clearance for welding each arc of the half-pipe to the exterior of the vessel shell or head during the manufacturing process. In addition, a significant amount of welding is required to attach the half-pipe to the exterior of the vessel shell or head in a spiral orientation. To manufacture a conventional half-pipe jacketed vessel, the half-pipe conduit is positioned adjacent to the vessel shell or head with each side of the half-pipe abutting the exterior surface of the shell or head. Each side of the half-pipe is then individually welded to the vessel shell or head, typically utilizing a continuous fillet welding joint, to join each of the two sides of the half-pipe to the vessel shell or head along the length of the half-pipe. Thus, each side of the half-pipe requires at least one weld pass to join the half-pipe to the shell or head. In some cases, a second weld pass may be performed on each side of the half-pipe in order to provide additional strength in the weld joint and minimize the risk of cracking at the joint. Thus, at least two weld passes (one for each side of the half-pipe) are required to weld a length of half-pipe jacket to a vessel shell or head, and sometimes as many as four weld passes may be performed for a length of half-pipe jacketing. Accordingly, the manufacturing process requires significant welding to the exterior of the vessel shell or head. This intensive welding process increases the cost of manufacturing half-pipe jacketed vessels and may account for as much as thirty percent of the cost of manufacturing a vessel. In addition, the required amount of welding can cause mechanical concerns when thermal cycling occurs. Thus, for instance, welding conduit to a vessel head in a spiral orientation on the exterior surface of the vessel head may result in decreased fatigue resistance of the jacket-to-head welds on the walls of the heads of the vessel.

Some jacket designs have incorporated modified half-pipe jacketing to increase the surface area of the shell or head that is covered by the jacket and to minimize the welding required to install a jacket onto the exterior of the shell or head of a vessel. However, such designs still utilize spirally arranged conduit, which can be difficult to install onto vessel heads, which may exist in many varied shapes and configurations, without potentially expensive and time-consuming tooling. Spiral conduit on vessel heads also may not provide maximum coverage of the vessel heads to maximize the efficiency of temperature control at the heads.

Accordingly, there is a need in the art for improved jacketing on vessel heads and improved methods of manufacturing vessels with jacketed heads.

### SUMMARY

In one aspect, a vessel with one or more jacketed heads and a method of manufacturing a vessel with jacketed heads for temperature control of contents within the vessel are provided. The vessel may comprise a shell and two opposing heads, each of which has an exterior surface on which an external jacket may be installed. The external jacket comprises a plurality of conduit rings that are concentrically arranged. Each of the conduit rings generally has an annular shape and is integrally attached to the exterior surface of at least one head of the vessel. The exterior surface of the head and an interior side of each conduit ring define a fluid passageway within each of the conduit rings. The jacket further comprises a jumper line connecting each individual conduit ring to an adjacent conduit ring so that each of the adjacent conduit rings of the plurality of conduit rings are in fluid communication with each other through one of the jumper lines. The plurality of conduit rings includes an innermost conduit ring and an outermost conduit ring, and the jacket preferably further includes at least one interior conduit ring disposed between the innermost conduit ring and the outermost conduit ring. A fluid inlet line is preferably connected to the innermost conduit ring, and a fluid outlet line is preferably connected to the outermost conduit ring. Heating or cooling fluid may be circulated successively through adjacent conduit rings so that the heating or cooling fluid contacts the exterior surface of the head of the vessel to cause heat transfer between the heating or cooling fluid and the walls of the vessel head. The heating or cooling fluid may enter the jacket through the fluid inlet line and flow through the innermost conduit ring, then flow to an outwardly adjacent conduit ring through a jumper line, and so on, until the heating or cooling fluid exits the jacket through the fluid outlet line after flowing through the outermost conduit ring.

Each conduit ring preferably has a center portion and two opposing side portions that are each integrally formed with the center portion. The center portion has a concave inner surface, and the opposing side portions include an inner side portion extending around an inner circular perimeter of the conduit ring and an outer side portion extending around an outer circular perimeter of the conduit ring. The inner side portion and the outer side portion of each conduit ring are flared outwardly from the center portion. The center portion preferably has a 2:1 semi-elliptical cross-sectional shape. The side portions may be integrally attached to the exterior surface of the vessel head, preferably by a welding joint, to form the attachment of the jacket conduit to the vessel head. Once attached, the interior side of the conduit ring, including the concave inner surface of the center portion, and the exterior surface of the head of the vessel form the passageway through which the heating or cooling fluid flows. The passageway of each conduit ring is enclosed along the annular flow path of the conduit ring, but inlet and outlet openings for fluid flow into and out of each conduit ring are located at connection points for each of the jumper lines and connection points for the fluid inlet and fluid outlet lines to allow the heating or cooling fluid to flow through each successive conduit ring for temperature control of the vessel contents.

During the manufacturing process of the vessel, the jacket conduit is welded to the exterior surface of one or both of the vessel heads. For optimal temperature control, jacket conduit may also be installed on the exterior surface of the shell of the vessel, which is preferably installed separately to form one or more heating or cooling zones that are separate from the heating or cooling zones on the heads of the vessel. Before welding, each conduit ring may be placed in a position in which the side portions of the conduit ring are abutting the exterior surface of the head due to the shape of the conduit ring with the side portions spreading outwardly from the concave center portion. This cross-sectional geometry allows a side portion of one conduit ring to be positioned adjacent to a side portion of an adjacent conduit ring while still providing spacing between the center portions of the adjacent conduit rings, which provides clearance for welding the conduit rings to the vessel. When conduit rings are positioned adjacent to each other, a welding joint formed by a single pass, full-penetration butt weld may be utilized to join adjacent side portions of adjacent conduit rings to each other and to the head of the vessel. Each of the conduit rings is preferably formed by hydroforming flat metal plates into shapes of separate sections of the conduit ring and then welding the sections to each other to form the full annular conduit ring.

The process of manufacturing the vessel with jacketed heads provides a number of advantages in terms of manufacturing costs, vessel reliability, and ease of manufacturing custom-fit jacketing for vessel heads having specific shapes. This process significantly reduces the required amount of welding, which reduces production costs. A full-penetration butt weld generally provides higher joint efficiency and increased fatigue resistance of the jacket-to-head weld as it reduces the possibility of a stress riser from a notch discontinuity. In addition, the cross-sectional geometry of the jacket conduit provides the ability to perform 100% radiography or ultrasonic inspections of the welding joint.

The foregoing summary has outlined some features of the device of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purposes of the device disclosed herein. Those skilled in the pertinent art should also realize that such equivalent designs or modifications do not depart from the scope of the device of the present disclosure.

### DESCRIPTION OF THE DRAWINGS

These and other features, aspects, and advantages of the present invention will become better understood with regard to the following description, appended claims, and accompanying drawings where:

FIG. 1 is a side elevation view of a vessel with jacketed heads in accordance with the present disclosure.

FIG. 2 is a side elevation view of a bottom jacketed head of a vessel in accordance with the present disclosure.

FIG. 3 is a bottom perspective view of a bottom jacketed head of a vessel in accordance with the present disclosure.

FIG. 4 is a bottom view of a bottom jacketed head of a vessel in accordance with the present disclosure.

FIG. 5 is a cross-sectional view of a jacketed head of a vessel in accordance with the present disclosure.

FIG. 6 is a detailed cross-sectional view of a portion of a jacketed head of a vessel in accordance with the present disclosure.

FIG. 7 is a detailed cross-sectional view of a portion of a jacketed head of a vessel in accordance with the present disclosure.

FIG. 8 is a detailed cross-sectional view of a portion of a jacketed head of a vessel in accordance with the present disclosure.

FIG. 9 is a cross-sectional view of a jacket conduit for a head of a vessel in accordance with the present disclosure.

FIG. 10 is a bottom view of a bottom jacketed head of a vessel showing a flow path through the jacket in accordance with the present disclosure.

FIG. 11 shows a section of conduit hydroformed from a flat plate in accordance with the present disclosure.

FIG. 12 is a side elevation view of the hydroformed section of conduit shown in FIG. 11.

FIG. 13 shows a top plan view of hydroformed sections of conduit welded together to form a circular conduit for a vessel head in accordance with the present disclosure.

FIG. 14 is a perspective view of the circular conduit shown in FIG. 13.

FIG. 15 is a partial cross-sectional view of a jacketed head of a vessel in accordance with the present disclosure.

FIG. 16 is a partial cross-sectional view of a conventional jacketed head of a vessel.

### DETAILED DESCRIPTION

In the Summary above and in this Detailed Description, and the claims below, and in the accompanying drawings, reference is made to particular features, including method steps, of the invention as claimed. In the present disclosure, many features are described as being optional, e.g. through the use of the verb “may”. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features, or with all three of the three possible features. It is to be understood that the disclosure in this specification includes all possible combinations of such particular features. For example, where a particular feature is disclosed in the context of a particular aspect or embodiment, or a particular claim, that feature can also be used, to the extent possible, in combination with/or in the context of other particular aspects or embodiments, and generally in the invention as claimed.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The present disclosure provides a vessel with one or more jacketed heads and a method of manufacturing a vessel with jacketed heads for temperature control of contents within the vessel in accordance with the independent claims. Preferred embodiments of the invention are reflected in the dependent claims. The claimed invention can be better understood in view of the embodiments described and illustrated in the present disclosure, viz. in the present specification and drawings. In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the invention per se.

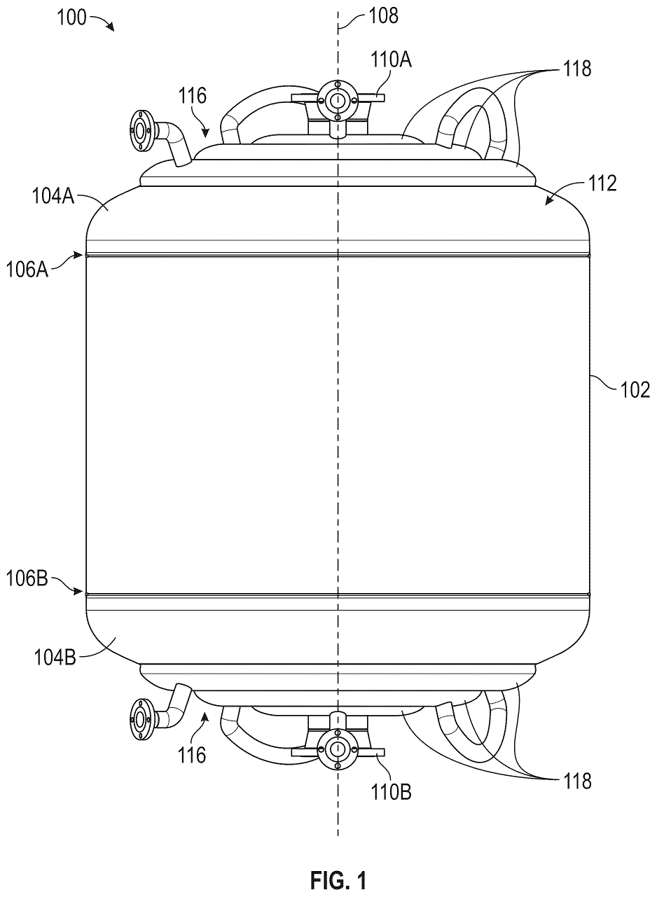

A vessel 100 with an external jacket 116 for temperature control of contents within the vessel is provided. The vessel 100 may comprise a shell 102 and two opposing heads 104 attached to opposing ends 106 of the shell 102. The shell 102 and each of the heads 104 has an exterior surface 112 on which the external jacket 116 may be installed. The vessel 100 may be used as a temperature-controlled continuous or batch reactor, or alternatively as a temperature-controlled mixing or storage vessel, depending on the application. FIG. 1 shows one embodiment of a vessel 100 having a jacket 116 installed on each head 104 in accordance with the present disclosure. In this case, the vessel 100 is a vertically oriented pressure vessel having a cylindrical shell 102. The vessel 100 has a top head 104A attached to an upper end 106A of the shell 102 and a bottom head 104B attached to a lower end 106B of the shell 102. The vessel 100 has separate jackets 116 installed on heads 104A and 104B to function as separate heating or cooling zones. An additional external jacket 116 may optionally be installed on the exterior surface of the shell 102 for better temperature control of the contents of the vessel 100. The heads 104 of the vessel 100 are preferably torispherical flanged and dished heads, though other suitable types of heads 104 may be utilized, including, but not limited to, elliptical heads, flat heads, hemispherical heads, or spherical caps.

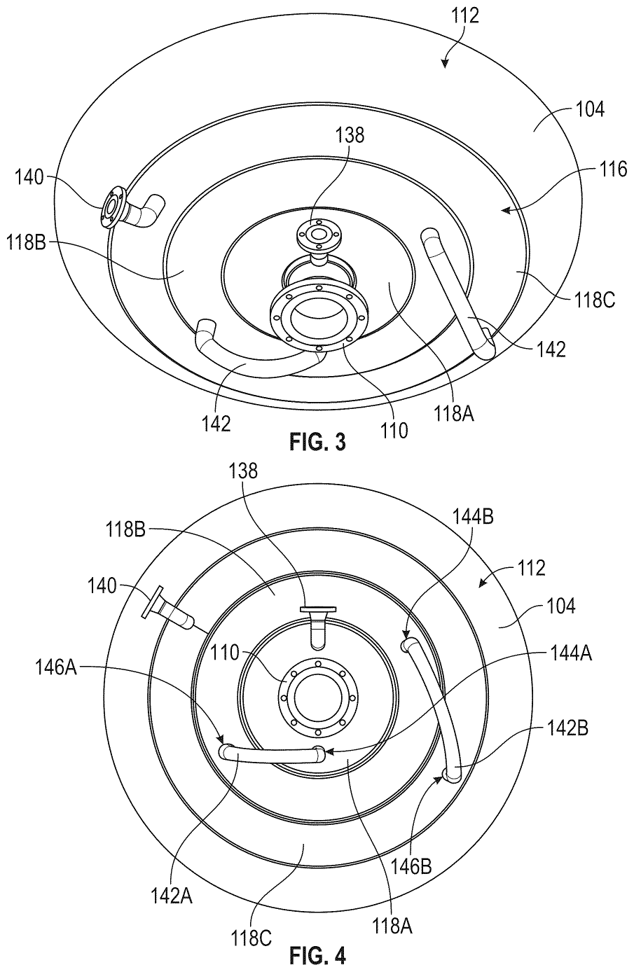

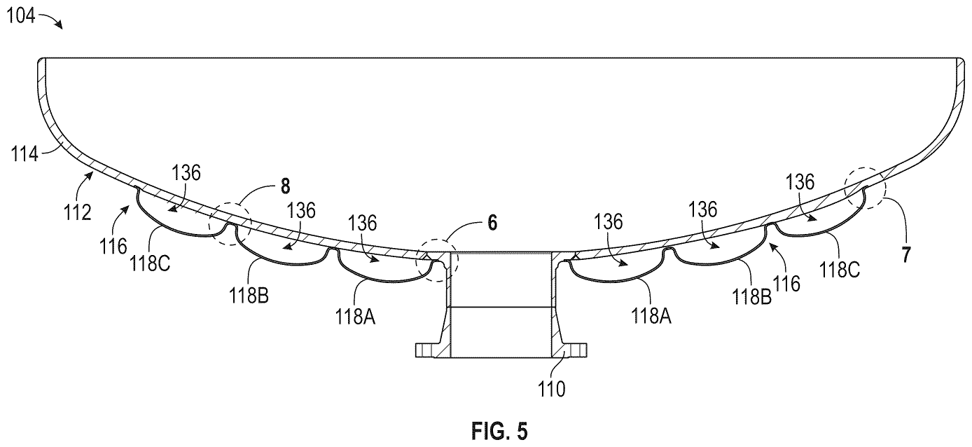

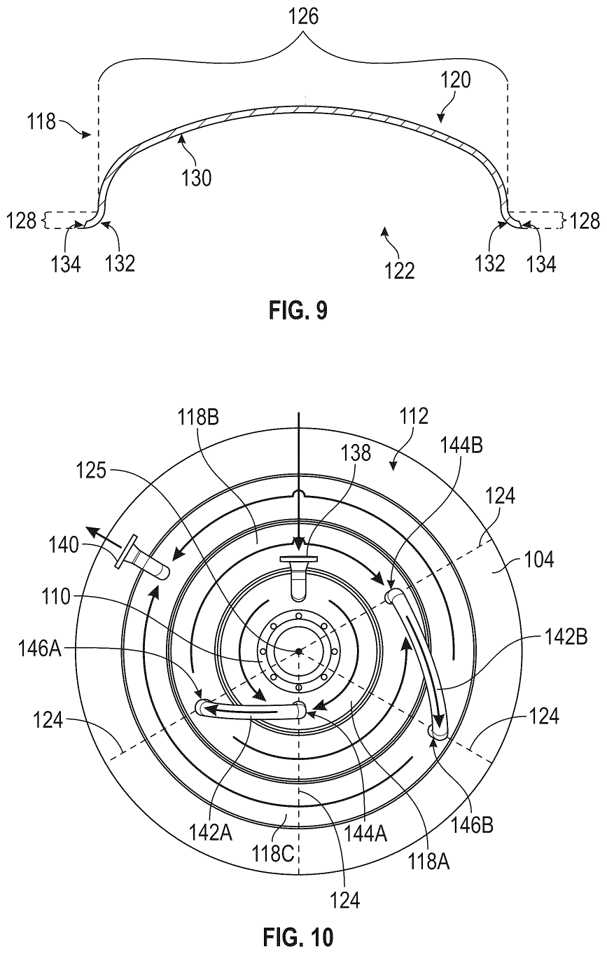

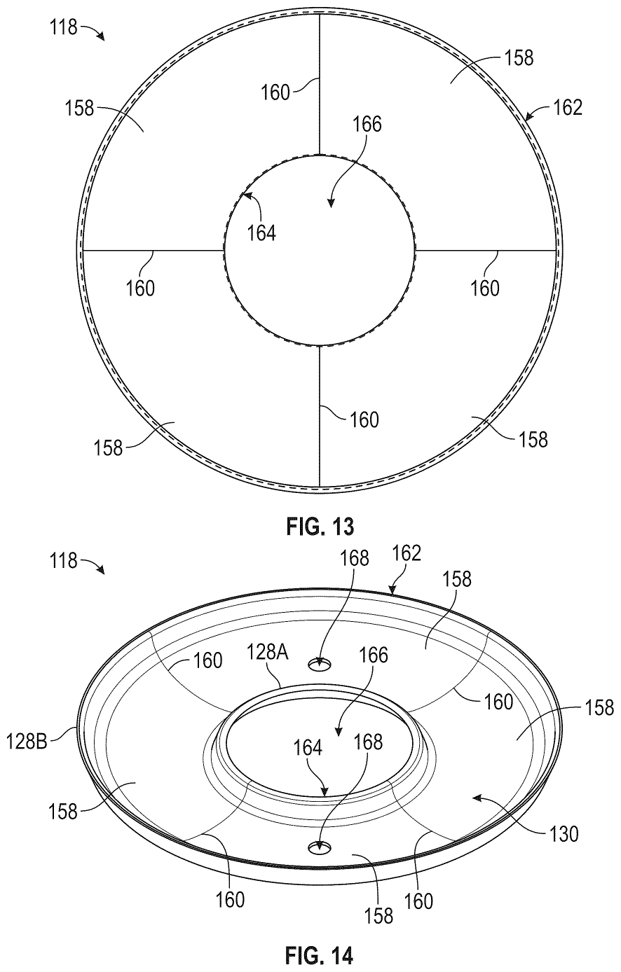

The jacket 116 comprises a plurality of conduit rings 118 that are concentrically arranged. As best seen in FIGS. 3 and 4, adjacent conduit rings 118 of the concentric arrangement are fluidly connected to each other by a jumper line 142 to allow heating or cooling fluid to flow between adjacent conduit rings 118. Each of the conduit rings 118 generally has an annular shape and is integrally attached to the exterior 112 surface of at least one head 104 of the vessel 100. FIGS. 13 and 14 show one conduit ring 118 detached from the vessel 100, and FIG. 9 shows a cross-sectional view of one conduit ring 118 detached from the vessel 100. When integrally attached to one of the vessel heads 104, the plurality of conduit rings 118 may be disposed in a concentric arrangement having a center point defined by an axis 108 of the vessel 100. In a preferred embodiment, the plurality of conduit rings 118 may be concentrically arranged around a fluid nozzle 110. The vessel 100 may include an inlet fluid nozzle 110A on the top head 104A and an outlet fluid nozzle 110B on the bottom head 104B, both of which may be surrounded by annular conduit rings 118. The fluid within the vessel 100 to be heated or cooled may enter the vessel through the inlet fluid nozzle 110A and exit the vessel 100 through the outlet fluid nozzle 110B. FIG. 5 shows a cross section of a vessel head 104 with concentric conduit rings 118 arranged around a fluid nozzle 110 (jumper lines 142 not shown). The exterior surface 112 of the head 104 and an interior side 122 of each conduit ring 118 define a circular fluid passageway 136 within each of the conduit rings 118. Although the conduit rings 118 are preferably installed on the heads 104 of a vessel 100, the conduit rings 118 may optionally also be installed on the shell of a vessel. For instance, concentrically arranged conduit rings 118 may be installed on a pressure vessel having a spherical shape.

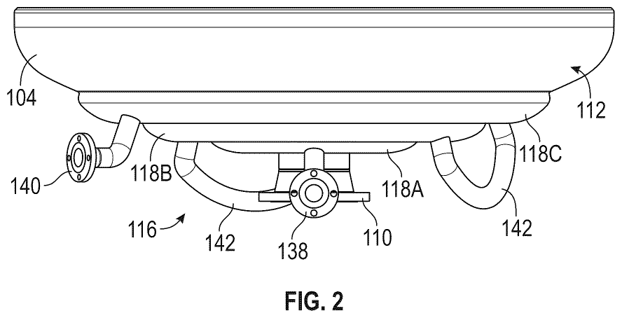

The plurality of conduit rings 118 includes an innermost conduit ring 118A and an outermost conduit ring 118C. In a preferred embodiment, as best seen in FIGS. 2-5, the jacket 116 preferably further includes at least one interior conduit ring 118B disposed between the innermost conduit ring 118A and the outermost conduit ring 118C. Thus, interior conduit ring 118B is disposed adjacent to innermost conduit ring 118A in a concentrically outward position from conduit ring 118A, and outermost conduit ring 118C is disposed adjacent to interior conduit ring 118B in a concentrically outward position from conduit ring 118B. The jacket 116 may optionally include a plurality of interior conduit rings 118B depending on the size of the vessel head 104 and the size of the conduit rings 118. The figures illustrate an embodiment having three concentric conduit rings 118, though it should be understood that the number of conduit rings 118 may vary and still fall within the scope of the present disclosure. The jacket 116 comprises at least one jumper line 142, and in the embodiment having three conduit rings 118 the jacket 116 includes two jumper lines 142. Thus, as illustrated in FIG. 4, the jacket 116 includes a first jumper line 142A fluidly connecting the innermost conduit ring 118A to the interior conduit ring 118B and a second jumper line 142B fluidly connecting the interior conduit ring 118B to the outermost conduit ring 118C. The first jumper line 142A has a first end 144A connected to the innermost conduit ring 118A and a second end 146A connected to interior conduit ring 118B. Similarly, the second jumper line 142B has a first end 144B connected to interior conduit ring 118B and a second end 146B connected to the outermost conduit ring 118C. Thus, the opposing ends of each jumper line 142 are connected to adjacent conduit rings 118 of the plurality of conduit rings 118 such that each pair of adjacent conduit rings 118 of the plurality of conduit rings 118 are in fluid communication with each other through one of the jumper lines 142. In an alternative embodiment, jumper lines 142 may be connected to non-adjacent conduit rings 118. For instance, a jumper line 142 may alternatively connect conduit ring 118A directly to conduit ring 118C, in which case the heating or cooling fluid may flow through the conduit rings 118 in a non-adjacent flow path.

The jacket 116 also includes a fluid inlet line 138 through which the heating or cooling fluid enters the jacket 116 and a fluid outlet line 140 through which the heating or cooling fluid exits the jacket 116. Lines for heating or cooling fluid from an external source may be connected to flanges of the fluid inlet line 138 and the fluid outlet line 140 to supply the heating or cooling fluid to the jacket 116. The fluid inlet line 138 is preferably connected to the innermost conduit ring 118A, and the fluid outlet line 140 is preferably connected to the outermost conduit ring 118C. Alternatively, the positions of the fluid inlet line 138 and fluid outlet line 140 may be reversed to reverse the flow direction of the heating or cooling fluid. FIG. 10 illustrates the preferred flow path of the heating or cooling fluid through the jacket 116. The heating or cooling fluid may be circulated successively through adjacent conduit rings (preferably 118A, then 118B, and then 118C) so that the heating or cooling fluid contacts the exterior surface 112 of the head 104 of the vessel 100 to cause heat transfer between the heating or cooling fluid and a wall 114 of the vessel head 104. The heating or cooling fluid may enter the jacket through the fluid inlet line 138, flow through the innermost conduit ring 118A, and then flow through the first jumper line 142A to the outwardly adjacent interior conduit ring 118B. The heating or cooling fluid may then flow through the interior conduit ring 118B and then flow through the second jumper line 142B to the outwardly adjacent outermost conduit ring 118C. The heating or cooling fluid may then exit the jacket 116 through the fluid outlet line 140. If the jacket 116 includes additional conduit rings 118, the heating or cooling fluid preferably flows successively through each of the adjacent conduit rings 118 from the innermost conduit ring 118A to the outermost conduit ring 118C.

In a preferred embodiment, as best seen in FIGS. 4 and 10, a location at which the first end 144A of the first jumper line 142A is connected to the innermost conduit ring 118A is angularly offset by an angle of approximately 180 degrees relative to axis 108 from a location at which the fluid inlet line 138 is connected to the innermost conduit ring 118A. Thus, a straight line may pass through a center point 125 of the concentrically arranged conduit rings 118 and also through the locations at which the first end 144A of the first jumper line 142A is connected to the innermost conduit ring 118A and at which the fluid inlet line 138 is connected to the innermost conduit ring 118A. As indicated by the flow direction arrows shown in FIG. 10, this configuration allows the flow of heating or cooling fluid to split when it enters conduit ring 118A and flow around opposite sides of the conduit ring 118A before joining and exiting the conduit ring 118A through the first jumper line 142A. Similarly, a location at which the second end 146A of the first jumper line 142A is connected to interior conduit ring 118B is preferably angularly offset by an angle of approximately 180 degrees relative to axis 108 from a location at which the first end 144B of the second jumper line 142B is connected to interior conduit ring 118B. In addition, a location at which the second end 146B of the second jumper line 142B is connected to outermost conduit ring 118C is preferably angularly offset by an angle of approximately 180 degrees relative to axis 108 from a location at which the fluid outlet line 140 is connected to outermost conduit ring 118C. This configuration allows the flow of heating or cooling fluid to split when it enters each successive conduit ring 118 and flow around opposite sides of each conduit ring 118 before joining and exiting the conduit ring 118 through either a jumper line 142 to the next outwardly adjacent conduit ring 118 or through the fluid outlet line 140 when exiting the jacket 116.

FIG. 9 shows a cross section of a preferred embodiment of a general shape of each of the plurality of conduit rings 118 before the conduit ring 118 is integrally attached to the exterior surface 112 of the vessel 100. FIGS. 13 and 14 show a preferred embodiment of one fully formed conduit ring 118 before the conduit ring 118 is integrally attached to the exterior surface 112 of the vessel 100. Each conduit ring 118 of the plurality of conduit rings 118 preferably has a center portion 126 and two opposing side portions 128 each integrally formed with the center portion 126. As illustrated in FIG. 9, the center portion 126 has a concave inner surface 130, and the side portions 128 of each conduit ring 118 are preferably flared outwardly from the center portion 128. Each conduit ring 118 has an exterior side 120 and an interior side 122 that faces toward the exterior surface 112 of the vessel 100. The side portions 128 may be integrally attached to the exterior surface 112 of the vessel 100 so that the fluid passageway 136 is generally defined by a space disposed between the concave inner surface 130 of the conduit ring 118 and the exterior surface 112 of the vessel 100. As used herein, the term “conduit ring” refers generally to a conduit structure having an annular shape with a central opening 166 in the conduit structure. The annular conduit structure forms a generally circular passageway for conveying fluid and is open on the interior side 122 of the conduit structure so that the open side 122 of the conduit structure may be positioned against a second structure, which is a wall 114 of a vessel head 104 or shell 102, to form the passageway between the two structures. The conduit ring 118 is preferably configured to allow fluids to flow in a completely circular flow path through the annular conduit ring 118, though in alternative embodiments, the conduit ring 118 may have an internal baffle that restricts flow to a defined direction. As used herein, the term “integrally attached” means that the conduit ring 118 is attached to the vessel 100 along the side portions 128 of the conduit ring 118 so that fluid cannot leak through an attachment point and that the conduit ring 118, once attached, cannot be detached from the vessel 100 without causing permanent damage to the conduit ring 118 or to the head 104 or shell 102 of the vessel 100. Each conduit ring 118 is preferably integrally attached to the exterior surface 112 of the vessel 100 by a welding joint.

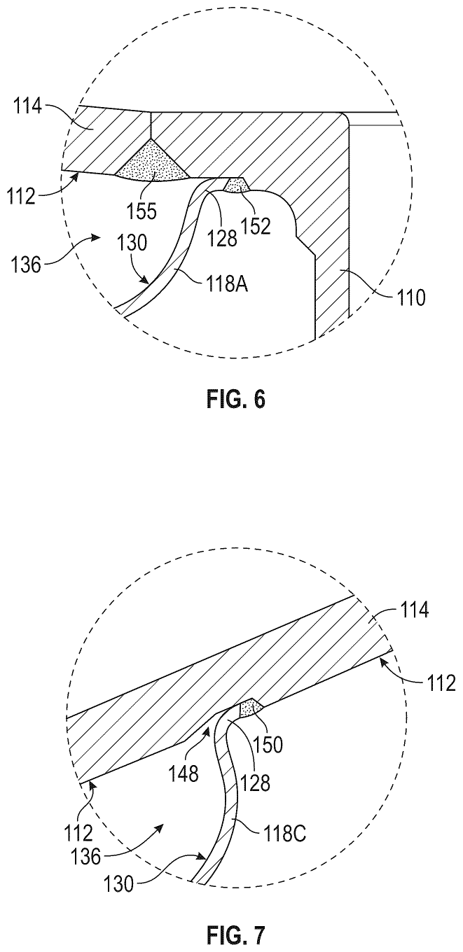

As best seen in FIG. 14, the opposing side portions 128 of each conduit ring 118 include an inner side portion 128A extending around an inner circular perimeter 164 of the conduit ring 118 and an outer side portion 128B extending around an outer circular perimeter 162 of the conduit ring 118. The center portion 126 of each conduit ring 118 preferably has a 2:1 semi-elliptical cross-sectional shape with the inner side portion 128A and outer side portion 128B forming knuckles that flare outwardly from the center portion 126, as best seen in FIG. 9. Alternatively, the center portion 126 of each conduit ring 118 may have a different cross-sectional shape having a concave inner surface 130, such as a cross-sectional shape of a circular segment, such as a semicircular segment or smaller circular segment, a parabolic shape, or any other suitable curved structure. The cross-sectional shape of each conduit ring 118 is preferably symmetrical. The interior side of each conduit ring 118 may have a curved transition between the concave inner surface 130 of the center portion 126 and a convex inner surface 132 of each of the opposing side portions 128 at an inflection point. Thus, once the conduit ring 118 is attached to the vessel 100, the fluid passageway 136 may be defined by the concave inner surface 130 of the center portion 126, the convex inner surface 132 of each side portion 128, and the exterior surface 112 of the vessel 100. Each side portion 128 of each conduit ring 118 is preferably configured so that at least a portion of each side portion 128 generally lays flush against the exterior surface 112 of the head 104 when the conduit ring 118 is positioned abutting the head 104, as best seen in FIGS. 6-8, to facilitate attachment of the conduit ring 118 to the head 104. As shown in FIG. 9, a terminal end of each outwardly flared side portion 128 preferably has a beveled edge 134 to facilitate welding each conduit ring 118 to an adjacent conduit ring 118 and to the head 104.

To manufacture the vessel 100 with the jacket 116 comprising concentrically arranged conduit rings 118, each of the conduit rings 118 are welded to the exterior surface 112 of one or both of the vessel heads 104 and/or, optionally, to a shell 102 of the vessel 100 separate from the heads 104. Thus, the vessel 100 and conduit rings 118 are preferably both constructed of a weldable material, such as a metal, metal alloy, or thermoplastic. Preferably, the construction material may be steel. The material of construction of both the conduit rings 118 and the vessel heads 104 and shell 102 may be selected based on weldability as well as on the intended application, including consideration of the process-side and jacket-side fluids that will flow through the vessel 100 and through the jacket 116, respectively. The vessel 100 may be constructed by any known method suitable for constructing a vessel 100 and may be pressure rated in accordance with operating specifications.

Before welding the conduit rings 118 to the vessel 100, each of the conduit rings 118 may be individually manufactured so that each individual conduit ring 118 has an outer perimeter 162 and an inner perimeter 164 sized so that the plurality of conduit rings 118 can be arranged concentrically on the outer surface 112 of the vessel 100. In a preferred embodiment, each of the conduit rings 118 is formed into an appropriate shape by a hydroforming process that utilizes high-pressure hydraulic fluid to press a flat plate into a die having the appropriate shape for each individual conduit ring 118. In a preferred embodiment, each conduit ring 118 may be formed by separately hydroforming sections 158 of each conduit ring 118 from a plurality of flat plates 156 and then welding the formed sections 158 to each other to form one full annular conduit ring 118. In one preferred embodiment, each conduit ring 118 is formed from hydroforming four separate sections 158 of the conduit ring 118. FIG. 11 shows a flat plate 156 having a shape appropriate to form one quarter section 158 of a conduit ring 118 and the resulting hydroformed quarter section 158 of the conduit ring 118 having a center portion 126 with a concave inner surface 130 and opposing side portions 128A and 128B that are flared outwardly from the center portion 126 and that each have a convex inner surface 132. To this end, individual plates 156 for hydroforming may generally have a shape of a wedge-shaped cutout section of a plate having an annular shape. Once fully formed, the center portion 126 and opposing side portions 128A and 128B of the conduit ring 118 define a channel that is open along the interior side 122 of the conduit ring 118. The hydroforming method of manufacturing conduit rings 118 allows custom-fit jacketing for vessel heads 104 of various sizes and shapes to be produced in a timely, cost-effective manner with minimal tooling.

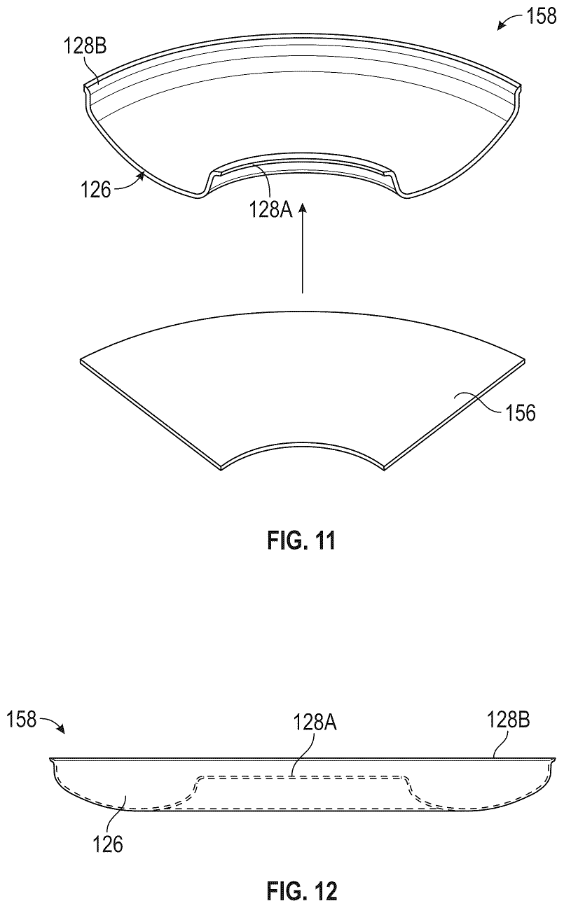

FIG. 12 shows one hydroformed section 158 of a conduit ring 118 shown in a position in which the conduit ring 118 may be installed on the head 104 of a vertical vessel 100. Thus, the inner side portion 128A of the conduit ring 118 may be lower than the outer side portion 128B due to the curvature of a torispherical head 104 or other type head having a curved structure. As best seen in FIG. 13, multiple hydroformed sections 158 may be welded together to form the complete conduit ring 118. Weld seams 160 may then be finished by a grinding and flushing process to ensure a continuous, flush surface between each of the sections 158 of the conduit ring 118 and to improve the fatigue resistance of the weld seam 160 by eliminating the stress concentration created by the weld profile. After welding the sections 158 together to form the conduit ring 118, openings 168 may be formed in the center portion 126 of the conduit ring 118 at locations where a jumper line 142 will be connected to the conduit ring 118 or where a fluid inlet line 138 or fluid outlet line 140 will be connected to the conduit ring 118. As shown in FIG. 14, two openings 168 may be formed in each conduit ring 118, preferably 180 degrees apart from each other relative to the center of central opening 166.

Before welding each conduit ring 118 to the exterior surface 112 of the head 104 of the vessel 100, the vessel head 104 is welded to the shell 102, and connections to the head 104 for inlet and outlet lines may be welded. For instance, in a preferred embodiment, as best seen in FIGS. 5 and 6, the vessel 100 includes a fluid inlet or outlet nozzle 110 for the flow of the process fluid into or out of the vessel 100. As best seen in FIG. 4, the fluid nozzle 110 is preferably positioned at a center of the plurality of concentrically arranged conduit rings 118. The head 104 may include an opening for installation of the fluid nozzle 110, and the fluid nozzle 110 and head 104 may have beveled edges to that the fluid nozzle 110 may be welded to the head 104 utilizing a butt weld 155, as shown in FIG. 6. Next, each conduit ring 118 may be placed in a position in which the side portions 128 of the conduit ring 118 are abutting the exterior surface 112 of the head 104. The inner side portion 128A of each conduit ring 118 may be welded to the exterior surface 112 of the head 104 to form an inner side welding joint at which the inner side portion 128A of each conduit ring 118 is integrally attached to the head 104. Similarly, the outer portion 128B of each conduit ring 118 may then be welded to the exterior surface 112 of the head 104 to form an outer side welding joint at which the outer side portion 128B of each conduit ring 118 is integrally attached to the head 104.

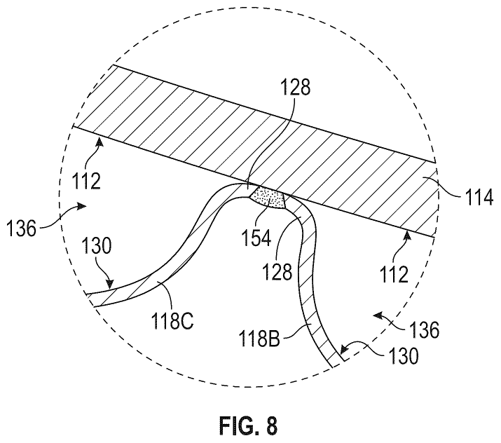

In a preferred embodiment, when each of the conduit rings 118 are placed in a position abutting the exterior surface 112 of the head 104, a side portion 128 of one conduit ring 118 may be positioned generally adjacent to a side portion 128 of an adjacent conduit ring 118, as best seen in FIG. 5. Thus, for example, the outer side portion 128B of the innermost conduit ring 118A may be positioned adjacent to the inner side portion 128A of outwardly adjacent interior conduit ring 118B, and the outer side portion 128B of the interior conduit ring 118B may be positioned adjacent to the inner side portion 128A of the outermost conduit ring 118C. Thus, a portion of the outer side portion 128B of the innermost conduit ring 118A that is abutting the wall 114 of the head 104 is generally in the same plane as a portion of the adjacent inner side portion 128A of adjacent conduit ring 118B that is also abutting the wall 114 of the head 104. When conduit rings 118 are positioned generally adjacent to each other so that adjacent side portions 128 are either directly contacting each other or in a position sufficiently close to each other for welding the side portions 128 to each other, a single welding joint formed by a single weld pass, full-penetration butt weld 154 may be utilized to join the outer side portion 128B of one conduit ring 118 to the inner side portion 128A of an adjacent conduit ring 118 and to simultaneously join both the inner side portion 128A and the outer side portion 128B of adjacent conduit rings 118 to the head 104 of the vessel 100, as shown in FIG. 8. The side portions 128 of the conduit rings 118 preferably have beveled edges 134 at the locations where the side portions 128 are welded to each other and to the wall 114 of the head 104. The cross-sectional geometry of the conduit rings 118 with the side portions 128 being flared outwardly from the center portion 126 allows side portions 128 of adjacent conduit rings 118 to be positioned adjacent to each other while still providing spacing between the center portions 126 of the adjacent conduit rings 118, which provides sufficient clearance between adjacent conduit rings 118 for welding the conduit rings 118 to the head 104.

In addition to the one or more interior butt welds 154, the inner side portion 128A of the innermost conduit ring 118A and the outer side portion 128B of the outermost conduit ring 118C are separately welded to the vessel 100 at an inner weld joint 152 and at an outer weld joint 150, respectively. In a preferred embodiment, as best seen in FIG. 6, the inner weld joint 152 joins the inner side portion 128A of the innermost conduit ring 118A to the fluid nozzle 110 that is welded to the head 104 at weld joint 155. The fluid nozzle 110 preferably has an exterior edge configured such that the inner side portion 128A of the innermost conduit ring 118A may be placed adjacent to the exterior edge of the fluid nozzle 110 so that a portion of the inner side portion 128A abutting the exterior of the fluid nozzle 110 is generally in the same plane as a portion of the fluid nozzle 110 to which inner side portion 128A is welded. This configuration allows the inner weld joint 152 to be welded as a full-penetration butt weld that extends entirely around an outer perimeter of the fluid nozzle 110 and entirely around the inner perimeter 164 of the innermost conduit ring 118A. The inner weld joint 152 integrally attaches the innermost conduit ring 118A to the fluid nozzle 110. Thus, in this embodiment, the exterior surface 112 of the head 104 that partially defines the fluid passageway 136 within the innermost conduit ring 118A may be defined, in part, by an exterior surface of the fluid nozzle 110 and an exterior surface of weld joint 155.

In a preferred embodiment, as best seen in FIG. 7, the head 104 of the vessel 100 to which the jacket 116 is welded has a circular groove 148 formed within the wall 114 of the head 104. The circular groove 148 extends in a complete circle that generally corresponds to the size of the outer perimeter 162 of the outermost conduit ring 118C. The circular groove 148 may be machined into the wall 114 of the head 104 when manufacturing the head 104. At least a portion of the outer side portion 128B of the outermost conduit ring 118C is disposed within the groove 148, and the outer side portion 128B of the outermost conduit ring 118C is integrally attached to the exterior surface 112 of the head 104 by the outer weld joint 150, which is disposed at least partially within the groove 148. The outer weld joint 150 extends around the outer perimeter 162 of the outermost conduit ring 118C. As shown in FIG. 7, the circular groove 148 has an edge configured such that the outer side portion 128B of the outermost conduit ring 118C may be placed adjacent to the edge of the circular groove 148 so that the portion of the outer side portion 128B abutting the wall 114 of the head 104 is generally in the same plane as a portion of the wall 114 of the head 104 to which outer side portion 128B is welded. This configuration allows the process of welding the outer side portion 128B of the outermost conduit ring 118C to the exterior surface 112 of the head 104 at the outer weld joint 150 to be performed by forming a full-penetration butt weld between the outer side portion 128B of the outermost conduit ring 118C and a portion of the wall 114 of the head 104 of the vessel 100 within the circular groove 148. The butt weld of the outer weld joint 150 extends entirely around the outer perimeter 162 of the outermost conduit ring 118C. The full-penetration butt weld at weld joint 150 in the machined groove 148, as well as similar full-penetration butt welds at inner weld joint 152 and at one or more interior weld joints 154, generally provide higher joint efficiency and increased fatigue resistance of the jacket-to-head weld as it reduces the possibility of a stress riser from a notch discontinuity.

After all of the conduit rings 118 are welded to the head 104 of the vessel 100, the fluid inlet 138, fluid outlet 140, and jumper lines 142 may be welded to the jacket 116. In a preferred embodiment, one end of each jumper line 142 is welded to the center portion 126 of one of the conduit rings 118, and the opposing end of the jumper line 142 is welded to the center portion 126 of an adjacent conduit ring 118 to form a fluid connection between the adjacent conduit rings 118. Similarly, the fluid inlet 138 is preferably welded to the center portion 126 of one of the conduit rings 118, which is preferably the innermost conduit ring 118A, and the fluid outlet 140 is preferably also welded to the center portion 126 of one of the conduit rings 118, which is preferably the outermost conduit ring 118C. The fluid inlet 138 and fluid outlet 140 preferably have flanges for connecting heating or cooling lines. Each of the fluid inlet 138, the fluid outlet 140, and the ends of the jumper lines 142 may be welded at the locations of openings 168 formed in the center portion 126 of the conduit rings 118. Each jumper line 142 preferably has bends configured to allow ends 144 and 146 to be welded to the conduit rings 118 at openings 168 while generally minimizing the distance that the heating or cooling fluid flows through the jumper line 142.

In a preferred embodiment, as best seen in FIG. 10, a location where the first end 144A of the first jumper line 142A is connected to the innermost conduit ring 118A is angularly offset from a location where the second end 146A of the first jumper line 142A is connected to adjacent conduit ring 118B. Similarly, a location where the first end 144B of the second jumper line 142B is connected to conduit ring 118B is angularly offset from a location where the second end 146B of the second jumper line 142B is connected to adjacent conduit ring 118C. If the jacket 116 includes additional conduit rings 118, the first end 144 of each jumper line 142 connecting adjacent conduit rings 118 is preferably angularly offset from the second end 146 of the jumper line 142. As used herein, the term “angularly offset” indicates that the locations at which the opposing ends 144 and 146 of the same jumper line 142 are connected to adjacent conduit rings 118 are not aligned along a straight line 124 having a starting point at a center point 125 of the concentrically arranged conduit rings 118 and extending outwardly from the center point 125 to the outermost conduit ring 118C. In a preferred embodiment, a line 124 extending from the center point 125 to the first end 144 of a jumper line 142 and a line 124 extending from the center point 125 to the second end 146 of the same jumper line 142 preferably form an angle of at least 15 degrees with the vertex of the angle being defined by the center point 125, as indicated in FIG. 10. An optimal angle of offset between the opposing ends 144 and 146 of a jumper line 142 may be based on the number of conduit rings 118 utilized for the jacket 116 so that connections attached to the same conduit ring 118 (such as inlet line 138 and the first end 144A of jumper line 142A) can have an angular offset of approximately 180 degrees. For instance, if a jacket 116 has only two conduit rings 118, then there are two total inlet fluid flow connections (inlet line 138 and the second end 146 of a jumper line 142) and two total outlet connections (outlet line 140 and the first end 144 of the jumper line 142). Thus, these four connections to the conduit rings 118 would preferably be angularly offset from each other by 90 degrees (360 degrees divided by four connections). Similarly, if a jacket 116 has six total conduit rings 118, there are twelve total connections (six inlet and six outlet) to the conduit rings 118. Thus, these twelve connections would preferably be angularly offset from each other by 30 degrees (360 degrees divided by 12 connections). Thus, in the embodiment shown in FIG. 10 that includes three conduit rings 118, the offset angle between each connection is preferably approximately 60 degrees. The connections to the conduit rings 118 are preferably offset from each other by an angle ranging between 15 degrees and 90 degrees. The angularly offset configuration of the weld connections of the jumper lines 142 and fluid inlet and outlet lines 138 and 140 distributes thermal stresses to improve fatigue resistance and prevent failures at the weld locations at which the ends 144 and 146 of the jumper lines 142 and fluid inlet and outlet lines 138 and 140 are connected to the conduit rings 118.

The design of the present vessel 100 and jacket 116 having concentrically arranged conduit rings 118 allows access for welding heads for welding interior weld joints 154 between adjacent conduit rings 118, improves fatigue life by introducing additional flexibility, and reduces thermal stresses by increasing the wetted area of the head 104 that is covered by the jacket 116. The conduit rings 118 of the jacket 116 may be formed fully or in parts and then welded together. The welding of all components may be performed utilizing metal inert gas (MIG) welding, tungsten inert gas (TIG) welding, laser welding, or a similar high quality welding method. The configuration of both the vessel 100 and conduit rings 118 allow for full-penetration butt weld joints 150, 152, 154, which eliminates the need for fillet welds or lap joints. The circular groove 148 machined into the head 104 of the vessel 100 and the configuration of the fluid nozzle 110 facilitate the use of butt welds at the outermost and innermost weld joints 150 and 152, respectively, which provides a jacket-to-head connection with enhanced fatigue resistance.

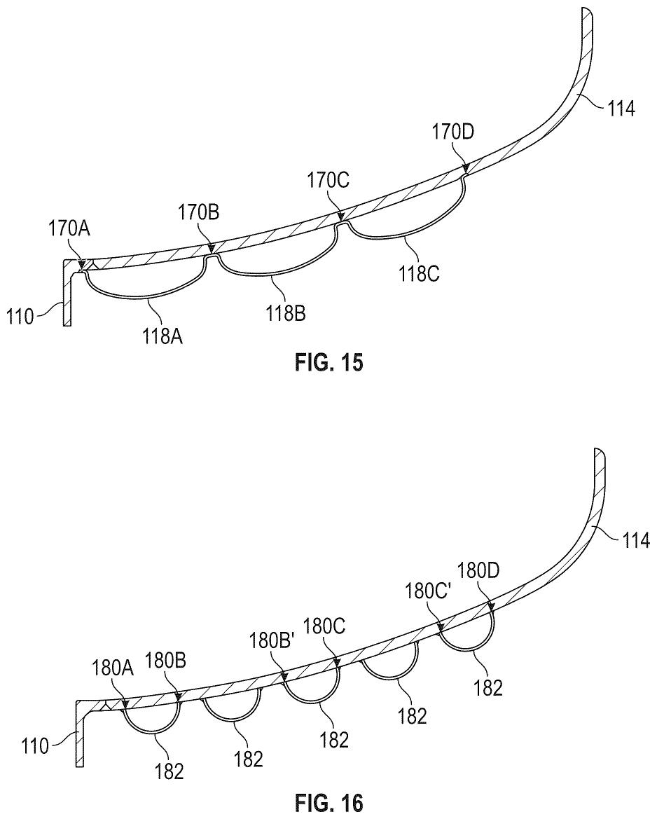

FIG. 15 shows a cross section of the present jacket 116 with three conduit rings 118 welded to the exterior surface 112 of the wall 114 of the head 104 of a vessel 100 at four weld locations 170, and FIG. 16 shows a cross section of a conventional jacket comprising half-pipe conduit 182 arranged in a spiral orientation on the head of the vessel and welded to the head at six weld locations 180 positioned along a line extending from the center of the head to the peripheral edge of the head (weld locations 180A, 180B′, and 180C′ represent the same continuous weld joint, and weld locations 180B, 180C, and 180D represent a second continuous weld joint, because the conduit 182 is a single length of spiraling conduit 182 with two continuous weld joints on opposing sides of the conduit 182). The conventional half-pipe conduit 182 comprises a semicircular segment of conduit with opposing ends of the semicircular segment welded directly to the head of the vessel using continuous fillet welds at a tee joint extending along the length of the conduit 182 since butt welds are not possible with this design. To illustrate improved fatigue resistance of the present jacket 116 design relative to a conventional half-pipe 182 jacket, a pressure vessel fatigue analysis was performed in accordance with American Society of Mechanical Engineers (ASME) standards set in the ASME Boiler and Pressure Vessel Code Section VIII, Division 2. The fatigue analysis was performed using ANSYS Mechanical software to analyze temperature cycle loading at each weld location 170, 180 to determine the number of cycles before failure. In one analysis, the cycle loading was based on temperature only. In a second analysis, the cycle loading was based on operating conditions, including temperature and pressure. In the temperature only analysis, the jacket side temperature cycled between 70 degrees Fahrenheit and 700 degrees Fahrenheit at atmospheric pressure. In the analysis under operating conditions, the jacket side temperature cycled between 70 degrees Fahrenheit and 700 degrees Fahrenheit at a pressure of 150 PSIG (pounds per square inch gauge). The results are shown in Table 1 below.

TABLE 1
Life cycle comparison for concentric conduit ring 118 jacket
versus conventional spiral design of half-pipe jacket 182.

| | Number of | Improvement | | |
|---|---|---|---|---|
| | Cycles | Factor | Number of | Improvement |
| Weld Location | (Temperature | (Temperature | Cycles | Factor |
| (FIGS. 15 and 16) | Only) | Only) | (Operating) | (Operating) |
| 170A | 185 | 46X | 870 | 145X |
| 180A | 4 | | 6 | |
| 170B | 573 | 9X | 1350 | 15X |
| 180B | 26 | | 43 | |
| 180B′ | 65 | | 92 | |
| 170C | 900 | 8X | 1676 | 9X |
| 180C | 110 | | 192 | |
| 180C′ | 59 | | 65 | |
| 170D | 661 | 4X | 2605 | 12X |
| 180D | 167 | | 224 | |

The results for the innermost weld locations 170A and 180A of conduit rings 118 and conventional jacket 182, respectively, were compared to determine an improvement factor of the concentric conduit ring 118 design of the jacket 116 compared to conventional jacket 182 under temperature-only cycling and operating condition cycling. Similarly, the results for the outermost weld locations 170D and 180D of conduit rings 118 and conventional jacket 182 were compared to determine an improvement factor for this location. For interior weld locations, the results for weld location 170B were compared to the results for both weld locations 180B and 180B′. Similarly, the results for weld location 170C were compared to the results for both weld locations 180C and 180C′. The improvement factor for each of weld locations 170B and 170C was then determined by comparing the result for weld location 170B to the best result obtained between weld locations 180B and 180B′ and comparing the result for weld location 170C to the best result obtained between weld locations 180C and 180C′. This method was used to approximate the analysis at similar locations on the vessel head because the interior weld locations of the conduit rings 118 and conventional jacket 182 are not the same due to the differences in design. The results shown in Table 1 illustrate an improvement in all cases of the present concentric conduit ring 118 design of the jacket 116 over the design of the conventional jacket 182. Thus, the present configuration of the vessel 100 and jacket 116 may be advantageous for high thermal fatigue applications, such as applications utilizing eutectic blends of phenyl oxides as heat transfer fluids, which may have operating temperatures up to 800 degrees Fahrenheit, molten salts from nuclear operations, which may have operating temperatures up to 1800 degrees Fahrenheit, or other similar high temperature applications. Such applications may operate in temperature ranges that are in the creep range of the materials of construction for the vessel 100 and jacket 116, and the present jacket 116 may prolong the life of the vessel 100 under such operating conditions.

The center portion 126 of the conduit rings 118 of the present jacket 116 preferably have an elliptical shape, so each conduit ring 118 covers a larger surface area of the head 104 than the conventional half-pipe jacket 182. The outwardly flared side portions 128 also allow adjacent conduit rings 118 to be welded to the head 104 in a single weld pass, which minimizes the number of weld joints compared to the conventional half-pipe jacket 182 and additionally increases surface area coverage of the head 104 of the vessel 100. Greater surface area coverage by the jacket 116 provides increased heating or cooling efficiency due to the larger surface area for heat transfer. As shown in FIG. 16, a conventional jacket has spacing between arcs of conduit 182 to provide clearance for welding operations when manufacturing the vessel. Thus, the surface area of the vessel head located between arcs of conduit 182 cannot be utilized for heat transfer. As shown in FIGS. 5 and 15, the conduit rings 118 of the present vessel 100 may cover substantially all of the exterior surface 112 of the head 104 located within the outer perimeter 162 of the outermost conduit ring 118C, including locations of interior weld joints 154 where side portions 128 are welded to the head 104. This coverage is possible due to the present geometry of the conduit rings 118, which allows the side portions 128 of each conduit ring 118 to be positioned generally adjacent to each other, rather than spaced significantly apart as in a conventional jacket conduit 182, while still providing adequate clearance between conduit rings 118 for welding operations.

An additional advantage of the cross-sectional geometry of the conduit rings 118 is the ability to perform 100% radiography or ultrasonic inspections of welding joints 150, 152, 154. To perform radiography testing, a source of radiation may be positioned over the interior butt-welded joints 154 between conduit rings 118 and a detecting device such as X-ray film may be positioned under the butt-welded joints 154 within the interior of the vessel 100. Similarly, to perform ultrasonic testing (UT), a UT probe may be positioned directly over the butt-welded joints 154 between conduit rings 118. Both types of testing are possible due to the type of weld and the weld joint geometry with a single weld joint 154 positioned between conduit rings 118.

The implementations set forth in the foregoing description do not represent all implementations consistent with the subject matter described herein but are examples consistent with the disclosed subject matter. Although variations have been described in detail above, other modifications or additions may be possible. It is understood that one of skill in the art would appreciate these various implementations and variations as falling within the scope of the present disclosure.

What is claimed) is:

1. A vessel comprising:
a shell;
a head attached to an end of the shell; and
a jacket comprising a plurality of conduit rings that are concentrically arranged, wherein each conduit ring of the plurality of conduit rings is integrally attached to an exterior surface of the head, wherein the exterior surface of the head and an interior side of each respective conduit ring of the plurality of conduit rings define a fluid passageway within each respective conduit ring of the plurality of conduit rings,
wherein the jacket further comprises at least one jumper line having a first end and a second end, wherein the first end of the at least one jumper line is connected to one respective conduit ring of the plurality of conduit rings, and wherein the second end of the at least one jumper line is connected to an adjacent conduit ring of the plurality of conduit rings such that adjacent conduit rings of the plurality of conduit rings are in fluid communication through the at least one jumper line.)

2. The vessel of claim 1, wherein each conduit ring of the plurality of conduit rings has a center portion and two opposing side portions each integrally formed with the center portion, wherein the center portion has a concave inner surface, wherein the opposing side portions include an inner side portion extending around an inner circular perimeter of each conduit ring and an outer side portion extending around an outer circular perimeter of each conduit ring, wherein the inner side portion and the outer side portion of each conduit ring are flared outwardly from the center portion.)

3. The vessel of claim 2, wherein the head has a circular groove formed within a wall of the head, wherein the plurality of conduit rings comprises an innermost conduit ring and an outermost conduit ring, wherein at least a portion of the outer side portion of the outermost conduit ring is disposed within the groove, wherein the outer side portion of the outermost conduit ring is integrally attached to the exterior surface of the head by a welding joint disposed at least partially within the groove and extending around an outer perimeter of the outermost conduit ring.)

4. The vessel of claim 2, wherein the vessel further comprises a fluid nozzle welded to the head, wherein the plurality of conduit rings comprises an innermost conduit ring and an outermost conduit ring, wherein the inner side portion of the innermost conduit ring is integrally attached to the fluid nozzle by a welding joint extending around an outer perimeter of the fluid nozzle.)

5. The vessel of claim 2, wherein the plurality of conduit rings comprises a first conduit ring and a second conduit ring, wherein the second conduit ring is disposed adjacent to the first conduit ring in a concentrically outward position from the first conduit ring, wherein the outer side portion of the first conduit ring is joined to the inner side portion of the second conduit ring by a welding joint.)

6. The vessel of claim 5, wherein the plurality of conduit rings further comprises a third conduit ring, wherein the third conduit ring is disposed adjacent to the second conduit ring in a concentrically outward position from the second conduit ring, wherein the at least one jumper line comprises a first jumper line and a second jumper line, wherein the first jumper line fluidly connects the first conduit ring to the second conduit ring, wherein the second jumper line fluidly connects the second conduit ring to the third conduit ring, wherein the first end of the first jumper line is connected to the first conduit ring at a first location and the second end of the first jumper line is connected to the second conduit ring at a second location that is angularly offset from the first location, wherein the first end of the second jumper line is connected to the second conduit ring at a third location and the second end of the second jumper line is connected to the third conduit ring at a fourth location that is angularly offset from the third location.)

7. The vessel of claim 6, wherein the second location at which the second end of the first jumper line is connected to the second conduit ring is angularly offset by approximately 180 degrees from the third location at which the first end of the second jumper line is connected to the second conduit ring.)

8. The vessel of claim 2, wherein the inner side portion and the outer side portion of each conduit ring each has a beveled edge.)

9. The vessel of claim 2, wherein the center portion of each conduit ring of the plurality of conduit rings has a 2:1 semi-elliptical shape.)

10. The vessel of claim 1, wherein the plurality of conduit rings comprises an innermost conduit ring and an outermost conduit ring, wherein the jacket further comprises a fluid inlet line connected to the innermost conduit ring and a fluid outlet line connected to the outermost conduit ring.)

11. A vessel having an exterior surface, wherein the vessel comprises a jacket, the jacket comprising a plurality of conduit rings that are concentrically arranged, wherein each conduit ring of the plurality of conduit rings is integrally attached to the exterior surface of the vessel, wherein the exterior surface of the vessel and an interior side of each respective conduit ring of the plurality of conduit rings define a fluid passageway within each respective conduit ring of the plurality of conduit rings, and
wherein the jacket further comprises at least one jumper line having a first end and a second end, wherein the first end of the at least one jumper line is connected to one respective conduit ring of the plurality of conduit rings, and wherein the second end of the at least one jumper line is connected to an adjacent conduit ring of the plurality of conduit rings such that adjacent conduit rings of the plurality of conduit rings are in fluid communication through the at least one jumper line.)

12. The vessel of claim 11, wherein each conduit ring of the plurality of conduit rings has a center portion and two opposing side portions each integrally formed with the center portion, wherein the center portion has a concave inner surface, wherein the opposing side portions include an inner side portion extending around an inner circular perimeter of each conduit ring and an outer side portion extending around an outer circular perimeter of each conduit ring, wherein the inner side portion and the outer side portion of each conduit ring are flared outwardly from the center portion.)

13. The vessel of claim 12, wherein the head has a circular groove formed within a wall of the head, wherein the plurality of conduit rings comprises an innermost conduit ring and an outermost conduit ring, wherein at least a portion of the outer side portion of the outermost conduit ring is disposed within the groove, wherein the outer side portion of the outermost conduit ring is integrally attached to the exterior surface of the head by a welding joint disposed at least partially within the groove and extending around an outer perimeter of the outermost conduit ring.)

14. The vessel of claim 12, wherein the plurality of conduit rings comprises a first conduit ring and a second conduit ring, wherein the second conduit ring is disposed adjacent to the first conduit ring in a concentrically outward position from the first conduit ring, wherein the outer side portion of the first conduit ring is joined to the inner side portion of the second conduit ring by a welding joint.)

15. The vessel of claim 14, wherein the plurality of conduit rings further comprises a third conduit ring, wherein the third conduit ring is disposed adjacent to the second conduit ring in a concentrically outward position from the second conduit ring, wherein the at least one jumper line comprises a first jumper line and a second jumper line, wherein the first jumper line fluidly connects the first conduit ring to the second conduit ring, wherein the second jumper line fluidly connects the second conduit ring to the third conduit ring, wherein the first end of the first jumper line is connected to the first conduit ring at a first location and the second end of the first jumper line is connected to the second conduit ring at a second location that is angularly offset from the first location, wherein the first end of the second jumper line is connected to the second conduit ring at a third location and the second end of the second jumper line is connected to the third conduit ring at a fourth location that is angularly offset from the third location.)

16. A method of manufacturing a vessel, said method comprising the steps of:
providing a vessel constructed of weldable material and having an exterior surface;
forming a plurality of conduit rings configured to be concentrically arranged on the exterior surface of the vessel, wherein each conduit ring of the plurality of conduit rings is constructed of weldable material and defines a channel that is open along on an interior side of each conduit ring, wherein each conduit ring of the plurality of conduit rings has a center portion and two opposing side portions each integrally formed with the center portion, wherein the center portion has a concave inner surface, wherein the opposing side portions include an inner side portion extending around an inner circular perimeter of each conduit ring and an outer side portion extending around an outer circular perimeter of each conduit ring, wherein the inner side portion and the outer side portion of each conduit ring are flared outwardly from the center portion;
welding the inner side portion of each conduit ring of the plurality of conduit rings to the exterior surface of the vessel to form an inner welding joint at which the inner side portion of each conduit ring of the plurality of conduit rings is integrally attached to the vessel;
welding the outer side portion of each conduit ring of the plurality of conduit rings to the exterior surface of the vessel to form an outer welding joint at which the outer side portion of each conduit ring of the plurality of conduit rings is integrally attached to the vessel, wherein the exterior surface of the vessel and the interior side of each respective conduit ring of the plurality of conduit rings define a fluid passageway within each respective conduit ring of the plurality of conduit rings;
welding one end of a jumper line to the center portion of each respective conduit ring of the plurality of conduit rings, and welding an opposing end of the jumper line to the center portion of an adjacent conduit ring of the plurality of conduit rings such that adjacent conduit rings of the plurality of conduit rings are in fluid communication through the jumper line.)

17. The method of claim 16, further comprising the step of machining a circular groove into a wall of the vessel, wherein the plurality of conduit rings comprises an innermost conduit ring and an outermost conduit ring, wherein at least a portion of the outer side portion of the outermost conduit ring is disposed within the groove, wherein welding the outer side portion of the outermost conduit ring to the exterior surface of the vessel to form the outer welding joint comprises forming a butt weld between the outer side portion of the outermost conduit ring and a portion of the wall of the vessel within the groove, wherein the butt weld extends around an outer perimeter of the outermost conduit ring.)

18. The method of claim 16, wherein the steps of welding the inner side portion and the outer side portion of each conduit ring of the plurality of conduit rings to the exterior surface of the vessel comprises forming a single welding joint in a single weld pass that joins the outer side portion of one respective conduit ring of the plurality of conduit rings to both the vessel and to the inner side portion of an adjacent conduit ring of the plurality of conduit rings.)

19. The method of claim 16, wherein the step of forming a plurality of conduit rings comprises providing a flat plate and hydroforming the flat plate into a shape of one respective conduit ring of the plurality of conduit rings.)

20. The method of claim 19, wherein the step of providing a flat plate and hydroforming the flat plate into a shape of one respective conduit ring of the plurality of conduit rings comprises separately hydroforming sections of the one respective conduit ring from a plurality of flat plates and then welding the sections to each other to form the one respective conduit ring.
